(19) United States
(12) Patent Application Publication
(10) Pub. No.: US 2006/0248337 A1
(43) Pub. Date: Nov. 2, 2006

(54) Establishment of a secure communication

(75) Inventor: Rajeev Koodli, Sunnyvale, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/159,146

(22) Filed: Jun. 23, 2005

Related U.S. Application Data
(60) Provisional application No. 60/675,858, filed on Apr. 29, 2005.

(51) Int. Cl. H04L 9/00; G06F 15/16; G06F 17/00; G06F 9/00

(52) U.S. Cl. 713/171; 713/153; 726/12; 726/15

(57) ABSTRACT

There is proposed a mechanism for establishing a secure communication between network elements in a communication network. The network nodes execute an authentication procedure with an authentication network element. The authentication network may also one of the network elements as a gateway element. Then, a respective data key for the network elements authenticated is generated and distributed to the gateway element by using a secure channel between the authentication network element and the gateway element. The data keys are stored the data keys in the gateway element. When a secure communication is to be setup, a respective session key is generated in the network elements intending to participate in the secure communication. The session keys are exchanged between the network elements intending to participate in the secure communication via secure channels between the gateway element and the network elements.

### REFERENCE TO RELATED APPLICATIONS

This application claims priority of U.S. Provisional Patent Application Ser. No. 60/675,858, filed Apr. 29, 2005. The subject matter of this earlier filed application is hereby incorporated by reference.

### BACKGROUND OF THE INVENTION

1. Field of the Invention

The present invention relates to a mechanism for establishing a secure communication between network elements in a communication network. In particular, the present invention relates to a method, a system and a network element called gateway element being usable for the creation of networks of trusted users, for example a peer-to-peer virtual private network in which users can securely communicate by using a dynamically formed network without requiring transmission through a corporate network or the like.

For the purpose of the present invention to be described herein below, it should be noted that

a network element acting as a communication device may for example be any device by means of which a user may access a communication network; this implies mobile as well as non-mobile devices and networks, independent of the technology platform on which they are based; only as an example, it is noted that network elements operated according to principles standardized by the 3^{rd} Generation Partnership Project 3GPP and known for example as UMTS elements are particularly suitable for being used in connection with the present invention;

a network element can act as a client entity or as a server entity in terms of the present invention, or may even have both functionalities integrated therein;

a content of communications may comprise at least one of audio data, video data, image data, text data, and meta data descriptive of attributes of the audio, video, image and/or text data, any combination thereof or even, alternatively or additionally, other data such as, as a further example, program code of an application program to be accessed/downloaded;

method steps likely to be implemented as software code portions and being run using a processor at one of the server/client entities are software code independent and can be specified using any known or future developed programming language;

method steps and/or devices likely to be implemented as hardware components at one of the server/client entities are hardware independent and can be implemented using any known or future developed hardware technology or any hybrids of these, such as MOS, CMOS, BiCMOS, ECL, TTL, etc, using for example ASIC components or DSP components, as an example;

generally, any method step is suitable to be implemented as software or by hardware without changing the idea of the present invention;

devices or network elements can be implemented as individual devices, but this does not exclude that they are implemented in a distributed fashion throughout the system, as long as the functionality of the device is preserved.

2. Description of the Related Art

In the recent years, an increasing expansion of communication networks, e.g. of wire based communication networks, such as the Integrated Services Digital Network (ISDN), or wireless communication networks, such as the cdma2000 (code division multiple access) system, cellular 3^{rd} generation communication networks like the Universal Mobile Telecommunications System (UMTS), the General Packet Radio System (GPRS), or other wireless communication system, such as the Wireless Local Area Network (WLAN), took place all over the world. Various organizations, such as the 3^{rd} Generation Partnership Project (3GPP), the International Telecommunication Union (ITU), 3^{rd} Generation Partnership Project 2 (3GPP2), Internet Engineering Task Force (IETF), and the like are working on standards for telecommunication networks and multiple access environments.

In general, the system structure of a communication network is such that one party, e.g. a subscriber's user equipment, such as a mobile station, a mobile phone, a fixed phone, a personal computer (PC), a laptop, a personal digital assistant (PDA) or the like, is connected via transceivers and interfaces, such as an air interface, a wired interface or the like, to an access network subsystem. The access network subsystem controls the communication connection to and from the user equipment and is connected via an interface to a corresponding core or backbone network subsystem. The core (or backbone) network subsystem switches the data transmitted via the communication connection to a destination party, such as another user equipment, a service provider (server/proxy), or another communication network. It is to be noted that the core network subsystem may be connected to a plurality of access network subsystems. Depending on the used communication network, the actual network structure may vary, as known for those skilled in the art and defined in respective specifications, for example, for UMTS, GSM and the like.

Generally, for properly establishing and handling a communication connection between network elements such as the user equipment and another user terminal, a database, a server, etc., one or more intermediate network elements such as control network elements, support nodes or service nodes are involved.

A special type of communication network represents so-called proximity networks. A proximity network is a relatively small, fairly short-range, often ad-hoc, network typically based on wireless transmission. An example for a proximity network is, for example, a corporate network or an enterprise solution in which tasks like document sharing, instant messaging, calendaring, conferencing and the like are typically executed by means of proximity networks.

One important aspect in communication connections, in particular in corporate networks where sensitive data can be transmitted, is the security of the communication. It is desirable and in some cases necessary to ensure that only the communicating parties are able to retrieve the information transmitted in a communication session and to prevent others from gathering sensitive data. Security of the communication can be achieved, for example, by using secure channels and encryption/decryption techniques for data/massages to be transmitted between the parties. For the establishment of a secure communication it is also necessary to verify that the other party is a trusted user/host, i.e. to ensure that the receiving party is authorized to become a part of the secure communication.

In document EP 1 458 151 (or US 2004/179502) filed by the present applicant a provision of security services for a mobile “Ad-Hoc” network is disclosed. In order to provide security services, a set of user identities is transmitted from a first ad-hoc node to a second network external to the ad-hoc network. The set of user identities includes user identities related to at least one ad-hoc node. A first set of authentication parameters is generated in the external network. The first set of authentication parameters includes an authentication vector for each user identity included in the set of user identities and each authentication vector including a second set of authentication parameters. Some of the authentication parameters of the second set are transferred to the first ad-hoc node, whereby a third set of authentication parameters is received at the first ad-hoc node. The third set of authentication parameters is utilized at the first ad-hoc node for providing a security service in the ad-hoc network.

### SUMMARY OF THE INVENTION

It is an object of the invention to provide an improved mechanism for dynamically establishing networks of trusted users, for example in a proximity network environment.

In particular, it is an object of the invention to provide a method and a corresponding system usable to form a peer-to-peer virtual private network enabling the secure transmission of data, and a specific network element or gateway element supporting the establishment of a secure communication between at least two hosts.

This object is achieved by the measures defined in the attached claims.

In particular, according to one aspect of the proposed solution, there is provided, for example, a method of establishing a secure communication between network elements in a communication network, the method comprising steps of executing an authentication procedure for a plurality of network elements with an authentication network element, setting one of the plurality of network elements as a gateway element, generating, in the authentication network element, a respective data key for the plurality of network elements authenticated, distributing the respective data keys of the plurality of network elements to the gateway element by using a secure channel between the authentication network element and the gateway element and storing the data keys in the gateway element, generating a respective session key in the network elements intending to participate in the secure communication, exchanging the respective session keys between the network elements intending to participate in the secure communication via secure channels between the gateway element and the network elements.

Furthermore, according to one aspect of the proposed solution, there is provided, for example, a system for establishing a secure communication between network elements in a communication network, the system comprising a plurality of network elements, a gateway element, an authentication network element being connectable to the gateway element; wherein the network elements are operably connected to as well as configured to execute an authentication procedure with the authentication network element, the authentication network element being configured to set one of the plurality of network elements as the gateway element, generate a respective data key for the plurality of network elements authenticated, and distribute the respective data keys of the plurality of network elements to the gateway element by using a secure channel between the authentication network element and the gateway element, and the gateway element is further configured to store the data keys, wherein the network elements are further adapted to generate, when it is intended to participate in a secure communication, a respective session key, and the gateway element is further adapted to support an exchange of the respective session keys between the network elements intending to participate in the secure communication by means of secure channels between the gateway element and the network elements.

Moreover, according to one aspect of the proposed solution, there is provided, for example, a gateway element usable in an establishment of a secure communication between network elements in a communication network, the gateway element comprising authenticating means adapted to execute an authentication procedure with an authentication network element, receiving means for receiving from the authentication network element data keys of network elements authenticated at the authentication network element by using a secure channel between the authentication network element and the gateway element, and storing means for storing the data keys of the network elements, wherein the gateway element is further adapted to support an exchange of respective session keys between network elements intending to participate in the secure communication by means of secure channels between the gateway element and the network elements.

Additionally, according to one aspect of the proposed solution, there is provided, for example, a gateway element usable in an establishment of a secure communication between network elements in a communication network, the gateway element being configured to execute an authentication procedure with an authentication network element, to receive from the authentication network element data keys of network elements authenticated at the authentication network element by using a secure channel between the authentication network element and the gateway element, and to store the data keys of the network elements, wherein the gateway element is further configured to support an exchange of respective session keys between network elements intending to participate in the secure communication by means of secure channels between the gateway element and the network elements.

Moreover, according to one aspect of the proposed solution, there is provided, for example, a gateway element usable in an establishment of a secure communication between network elements in a communication network, the gateway element being configured to receive a first message from a sending network element indicating a request to participate in a secure communication, said message comprising data identifying a destination network element, to verify that the gateway element has an entry for a route to the destination network element, wherein the gateway element is further configured to resolve the data identifying the destination network element to corresponding address data and to establish a route to the destination network element on the basis of the address data, when there is found no entry for a route, or to unicast a second message directly to the destination network element, when there is found an entry for a route.

Furthermore, according to one aspect of the proposed solution, there is provided, for example, authentication network element usable for establishing a secure communication between network elements in a communication network, the authentication network element being configured to execute an authentication procedure with network elements, to set one of the network elements as a gateway element, to generate a respective data key for the network elements authenticated; and to distribute the respective data keys of the network elements to the gateway element by using a secure channel between the authentication network element and the gateway element.

In addition, according to one aspect of the proposed solution, there is provided, for example, a terminal node configured to establish a secure communication in a communication network, the terminal node being configured to perform an authentication with an authentication network element, to generate, when it is intended to participate in a secure communication, a respective session key, to transmit the session key to a gateway element, and to exchange of session keys with at least one other terminal element also intending to participate in the secure communication by means of a secure channel to the gateway element.

According to further refinements, the proposed solution may comprise one or more of the following features:

the execution of an authentication procedure for a plurality of network elements may comprise an authentication and key agreement procedure between a respective one of the plurality of network elements and the authentication network element;

the execution of an authentication procedure for a plurality of network elements may further comprise a transmission, by one of the plurality of network elements, of an indication of willingness to become the gateway element, wherein the authentication network element may set one of the plurality of network elements as the gateway element on the basis of a processing of the indication of willingness;

the generation, in the authentication network element, of a respective data key may comprise a usage of at least one of a session key generated in the authentication procedure of the respective network element, identification data of the network element, and an identification element associated with the gateway element, for calculating the respective data key of a network device;

the exchange of respective session keys between the network elements intending to participate in the secure communication may comprise a transmission of a first packet comprising the session key generated by one (i.e. the sending) network element and data identifying a destination network element to the gateway node by using the data key of the one network element for encrypting the packet, a decryption of the first packet by using the data key of the one network element being stored in the gateway element, a processing of the content of the first packet for determining the destination network element, a forwarding to the destination network element the information comprised in the first packet by means of a second packet encrypted by the gateway element with the data key stored for the destination network element;

the distribution of the respective data keys of the plurality of network elements to the gateway element may comprise a usage of a session key generated in the authentication procedure of the gateway element at the authentication network element for encryption/decryption of information related to the data keys;

the network elements may be hosts, in particular mobile hosts, of the communication network;

the gateway element may be a router for the network elements which is adapted to provide access to external networks, such as the Internet, and internal networks, such as an Intranet;

the authentication network element may be an access network controller, in particular an access controller of a provider network;

the secure communication may be established in a proximity network environment, in particular in a peer-to-peer virtual private network environment; and

after the exchange of respective session keys between the network elements intending to participate in the secure communication, a bidirectional secure communication session may be established wherein the gateway element is not part of the communication path.

By virtue of the proposed solutions, the following advantages can be achieved:

The proposed mechanism is applicable in creating peer-to-peer virtual private networks (PVPN), in which users can communicate using a dynamically formed network without requiring a (traffic) transmission through the corporate network. In other words, it is possible that users form trusted proximity networks on-demand. This is in particular useful in cases where the subscriber terminals comprise different interfaces for communication, such as Bluetooth, infrared, WLAN (wireless local area network) capability or the like.

On the other hand, the authentication of network elements which intend to participate in the secure communication by means of the PVPN can be authenticated by using known authentication mechanisms using the provider's network infrastructure. Thus, the implementation of the invention is easy and less cost intensive since existing infrastructure is readily usable.

When a secure communication is established, i.e. when the session keys are exchanged, it is not necessary that the gateway element, which may also act as a router to the Internet, is involved in the secure communication path between the hosts. This facilitates the usage of alternative transmission interfaces, such as Bluetooth or the like, and reduces also the load on the gateway network element since it does not need to be involved in the communication as soon as it is established. Nevertheless, a secure communication is created.

By means of the mechanism for establishing a secure communication, it is possible to leverage cellular security and also to define a particular proximity network security management functionality in a particular network element, i.e. the gateway element. This is in particular useful in a cellular communication network, like a 3GPP or 3GPP2 based network, comprising mobile terminals or hosts as parties for the secure communication, as well as in corresponding proximity networks. Thus, it is possible for operators to exert some level of control by offering, for example, added functionality to improve security and usability of ad-hoc networks or the like.

According to the present invention, it can be avoided that sensitive information about the hosts, like the IMSI (International Mobile Subscriber Identity), is transmitted in an initial phase of the communication establishment without surely knowing that the receiving part is, for example, a trusted node.

The above and still further objects, features and advantages of the invention will become more apparent upon referring to the description and the accompanying drawings.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 shows block circuit diagram of a system for establishing a secure communication between two hosts according to an embodiment of the present invention.

FIG. 2 shows a generalized flow chart of a method of establishing a secure communication between two hosts according to an embodiment of the present invention.

FIG. 3 shows a flow chart of a subroutine of the method shown in FIG. 2 according to the embodiment of the present invention.

FIG. 4 shows a flow chart of another subroutine of the method shown in FIG. 2 according to the embodiment of the present invention.

FIGS. 5 and 6 show flow charts of another subroutine of the method shown in FIG. 2 according to the embodiment of the present invention.

### DETAILED DESCRIPTION OF THE PREFERRED EMBODIMENTS

In the following, an embodiment of the present invention is described with reference to the drawings.

According to the present embodiment, a mechanism for establishing a secure communication between two network elements or terminal nodes (also referred to as host or peer) by creating a so-called peer-to-peer virtual private network or PVPN (i.e. within a proximity) is described. In other words, two peers are assisted in the establishment of a secure channel for communication wherein a single secure channel between a gateway element (also referred to as gateway) and an authentication network element (also referred to as access controller) is used for performing authentication for all nodes or network elements participating in the secure communication.

As mentioned above, one network element being important for the creation of the PVPN according to the present embodiment is a node called gateway. The gateway enables two hosts in its network to securely communicate with each other. For this purpose, a secure channel between the gateway and a network element performing authentication (i.e. the access controller mentioned above) is required.

Generally, each host, which may be a mobile node or the like, that wishes to be a member of a PVPN has to perform an access network authentication. Additionally, a host (e.g. a mobile node) that wishes to act as the gateway element in the PVPN has to indicate so during the authentication procedure thereof. The gateway provides a secure channel for communication so that the peers can exchange each other's security parameters for securing their future communication. It is to be noted that the network element acting as the gateway preferably also provides connectivity to internal or external networks, such as the Internet and an Intranet, for hosts in its proximity network.

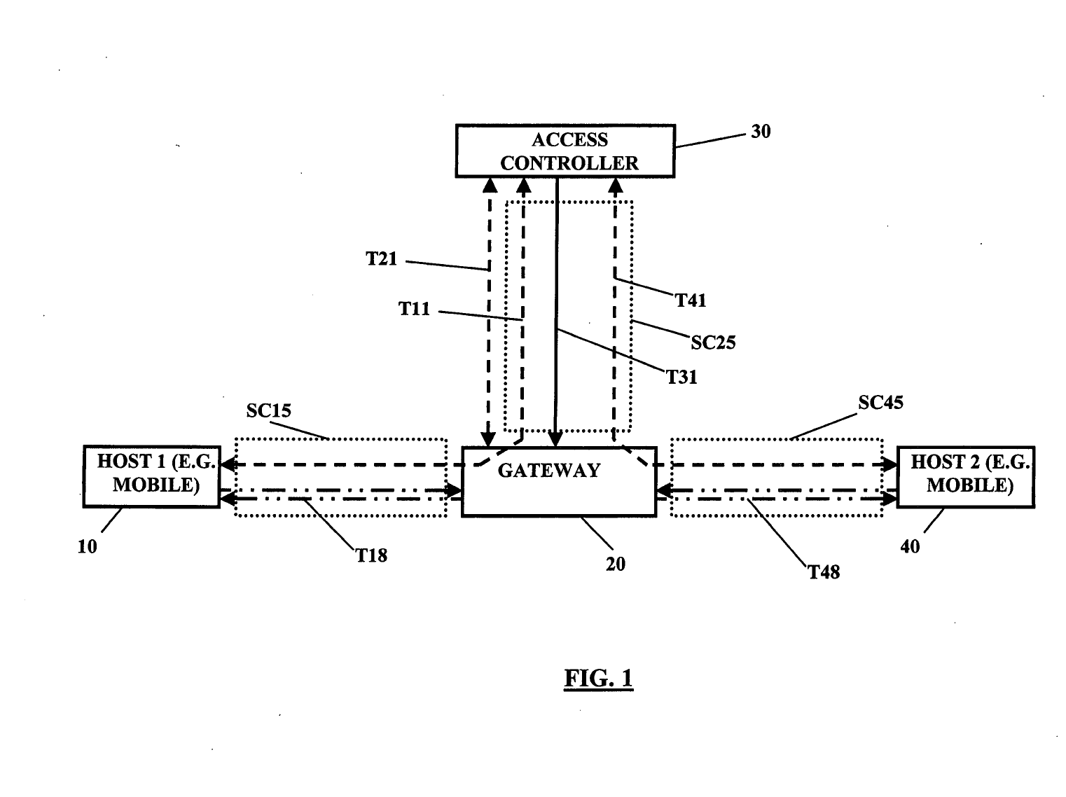

The network element performing authentication (i.e. the access controller as shown in FIG. 1 described below) securely distributes a session key tuple (to be described later), name (to be described later) and IP address corresponding to the hosts to the PVPN gateway wherein the parameters established during the authentication procedure of the PVPN gateway itself are used (i.e. for the transmission via the secure channel).

The initial communication within the PVPN between any two hosts takes place through the gateway. The reason is that each host, until it securely exchanges the key tuple with its intended peer, can communicate securely only with the gateway in the proximity network. The gateway provides the assurance that the name and IP address binding is reliable since it has received the binding from the access controller. Once the peers possess each other's session keys, it is not necessary that the gateway remains in the communication path between the peers.

It is to be noted that the access network authentication procedure can be effected by using well-known methods such as UMTS AKA (Authentication and key agreement, as described for example in 3GPP specification TS30.102, December 2004) or Kerberos (as described, for example, in RFC1510). The role of the access network provider is to ensure that the users (i.e. the hosts) belong to the same “entity” (such as a same company or enterprise). In addition, the users need the provider's network to access the corporate network. However, communication among the PVPN can take place using a proximity network such as WLAN, Bluetooth and the like.

Referring to FIG. 1, a simplified system structure as well as signaling paths for establishing a secure communication according to the present embodiment is shown. However, it is to be noted that the system according to FIG. 1 represents only a simplified architecture of such a system in which the present invention is implemented. Furthermore, the network elements and/or their functions described herein may be implemented by software or by hardware. In any case, for executing their respective functions, correspondingly used devices or network elements comprise several means (not shown in FIG. 1) which are required for control, processing and communication functionality. Such means may comprise, for example, a processor unit for executing instructions and processing data, memory means for storing instructions and data, for serving as a work area of the processor and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), and interface means for establishing a communication connection under the control of the processor unit (e.g. wired and wireless interface means, an antenna, and the like).

In FIG. 1, the overall procedure for the establishment of the PVPN is shown by means of a simplified illustration of a PVPN structure. Reference signs 10 and 40 denote network elements or hosts (for example mobile hosts) for which a secure communication via the PVPN is to be established. In the following, it is assumed that the host 1 (10) is the calling host and the host 2 (40) is the called host. Reference sign 20 denotes a network element acting as a gateway. As mentioned above, the gateway may also be a (mobile) host and may act as a router in the proximity network for providing connectivity to the Internet and the like. Reference sign 30 denotes an authentication network element or access controller which is connectable to the gateway 20 and is used for authentication of the hosts participating in the PVPN communication.

Also shown in FIG. 1, there are provided secure channels SC15, SC45 between the gateway 20 and the respective hosts 10, 40. In addition, a secure channel SC25 is provided between the access controller 30 and the gateway 20. The secure channels are indicated by dotted boxes and will be further described herein below.

Furthermore, several signaling paths between the network elements are indicated by means of arrows. In detail, dashed lined arrows T11, T21, T41 indicate signaling during an authentication of a one respective of the network elements 10, 20 and 40 with the access controller 30. On the other hand, chain-dotted lined arrows T18, T48 indicate a respective signaling during the setup of the secure connection (i.e. a session key exchange) between the hosts 10, 40 via the gateway 20. The signaling will be described below in greater detail.

As mentioned above, the host-1 10 and the Host-2 40 are peers interested in peer-to-peer secure communication. The gateway 20 is a node that facilitates secure peer-peer communication and is also a router for the (proximity) network consisting of the mobile hosts. The access controller 30 is a node that runs an authentication procedure understood by all the hosts in the proximity network. All the hosts including the gateway need to successfully authenticate themselves with the access controller before they can be part of the secure, on-demand network (i.e. the PVPN).

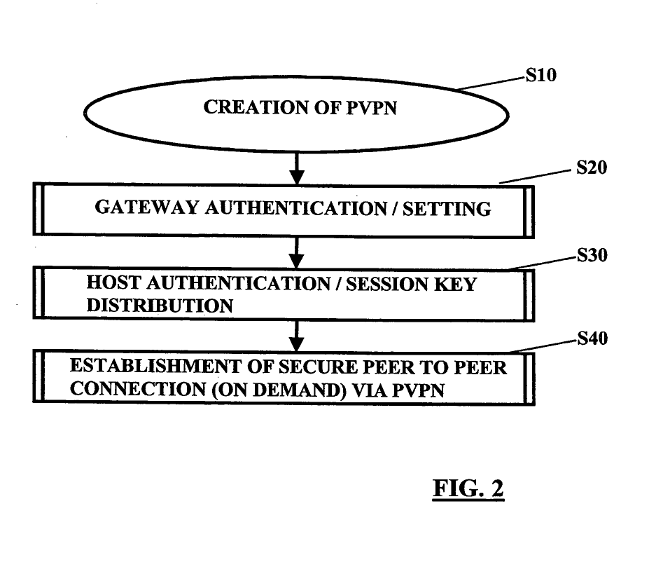

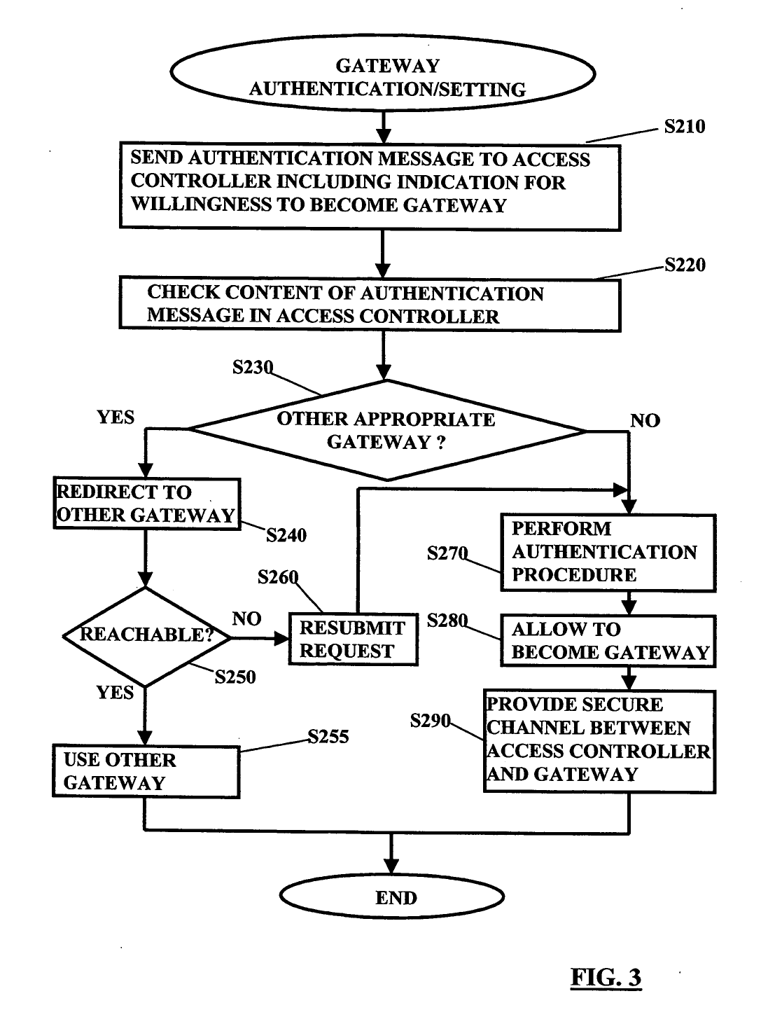

In FIG. 2, a general overview of the procedure for creating a PVPN and establishing the secure on-demand network (i.e. a secure peer-to-peer connection) is shown. After the procedure is started in step S10, first an authentication procedure and setting of the gateway 20 is performed by means of the authentication network element (access controller) 30 in step S20. Then, in step S30, authentication of hosts intending to participate in the PVPN with the authentication network element 30 as well as a session key distribution from the authentication network element 30 to the gateway 20 is executed. Finally, in step S40, the secure peer-to-peer communication is established by the hosts 10, 40 via the gateway 20. The sub-procedures according to steps S20, S30 and S40 are illustrated in FIGS. 3 (step S20), 4 (step S30) as well as 5 and 6 (step S40) described below.

In the following, details of the PVPN creation according to the present embodiment are described with reference to FIGS. 1 and 3 to 6.

It is to be noted that it is assumed that each user of a host has a generic name, such as a SIP URI (Session Initiation Protocol Universal Resource Identifier), and each host has configured a globally routable IP address.

When a network element (such as the calling Host-1 10 in FIG. 1, for example) wishes to be part of the PVPN, it either acts as a gateway or a host. When the network element intends to act as a gateway element, the procedure according to FIG. 3 (referring to step S20 in FIG. 2) is executed, which will be described next.

As mentioned above, each network element being part of the PVPN has to authenticate itself with the access controller 30. Thus, in step S210, the network element sends an authentication message (in order to become a part of the PVPN) to the access controller (signaling T21 in FIG. 1). In this authentication message, the network element includes an indication for its willingness to act as a gateway.

In the access controller 30, the content of the authentication message is checked in order to determine that the network node wishes to act as the gateway (step S220). In step S230 it is further decided whether there is already an appropriate gateway (i.e. another network element acting as a gateway) for the requesting host. This decision can be made, for example, by means of determining whether there is already an entry for a network element as acting as a gateway in a data table (not shown) or the like.

If the decision in step S230 is NO, i.e. the network element wishes to be a gateway and there is no appropriate gateway known, the access controller 30 allows the network element to act as the gateway 20 after successfully performing the authentication procedure, i.e. the network element is set as the gateway 20 (steps S270, S280). The authentication procedure in step S270 may involve multiple rounds of signaling and can be based, for example, on a method of authentication including a Challenge/Response mechanism of a UMTS AKA. Using UMTS AKA, the access controller may function similar to a SGSN/P-CSCF. In this case the PVPN join messages may include subnet solicitation and AKA authentication messages similar to an IMS (IP Mulimedia Subsystem) authentication procedure.

After steps S270, S280, the result of the successful gateway authentication is that its communication with the access controller 30 can be secured (step S290). This means that the communication between the access controller 30 and the gateway 20 can be encrypted/decrypted, for example, by means of a session key generated in the authentication procedure and is indicated by a secure channel SC25 in FIG. 1.

On the other hand, if there is already a gateway appropriate for the requesting host (NO in step S230), the access controller redirects the network element to this gateway (step S240). However, there may be the case that the network element is not able to reach the gateway determined by the access controller in step S230. This is checked in step S250 where the network element determines whether or not the gateway indicated by the access controller in connection with the NO decision of step S230 is reachable, for example.

If the decision of step S250 is YES, the gateway indicated by the access controller in connection with the NO decision of step S230 is used in the further communication (step S255). On the other hand, if the decision of step S250 is NO, the network element may re-submit the request to act as a gateway to the access controller 30 (step S260). Then, steps S270 to S290 are executed which means, for example, that the host authentication may include again a Challenge/Response method that involves at least one round of communication.

It is to be noted that it is a preferred option of the present embodiment that in the initialization phase of the PVPN, the very first network element performing the authentication procedure with the access controller as described above is set to act as the gateway by default.

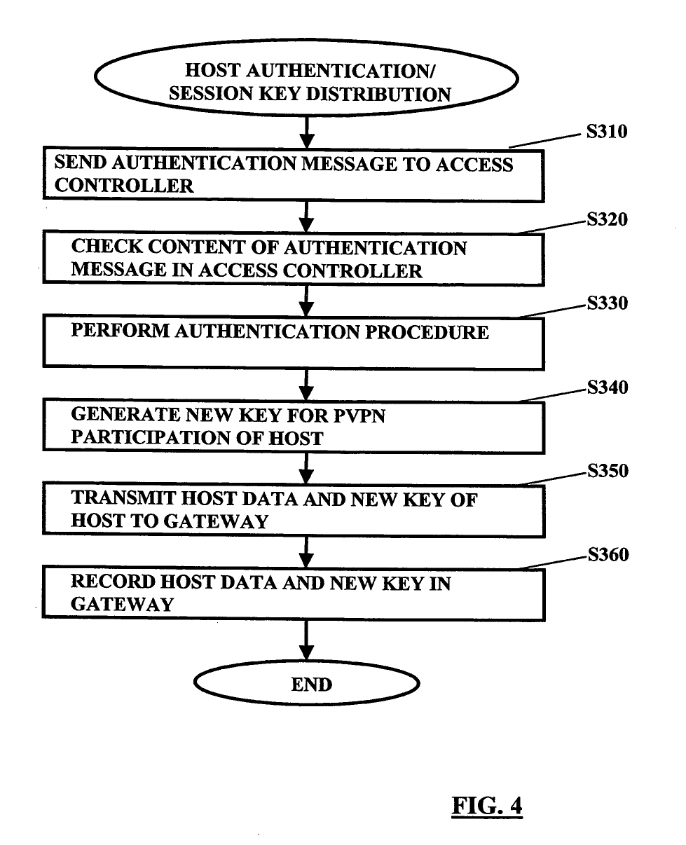

In case the network element does not send an indication for the willingness to become a gateway but wishes to act as a host only, the procedure shown in FIG. 4 for host authentication and session key distribution (in accordance with step S30 in FIG. 2) is executed.

In the procedure according to FIG. 4, steps 310 to 330 are similar to steps S210, S220 and S270 according to FIG. 3. In step S310, the network element or host (for example, 10 and 40 in FIG. 1) sends an authentication message to the access controller 30 (signaling paths T11, T41 in FIG. 1). The signaling for the authentication is performed via the gateway 20 as shown in FIG. 1 since the IP address of the host is derived from the gateway's 20 prefix. It is to be further noted that for the authentication of the hosts no secure channel is required. However, as will be described below, when data keys are transmitted from the access controller, such a secure channel is used. The access controller checks the content of the authentication message, e.g. for determining that the requesting host is part of a corporate network and thus generally authorized to become a member of the PVPN (step S320). If the check according to step S320 does not result in any obstacles for the authorization of the requesting host, the access controller 30 performs and completes the authentication procedure in step S330.

Once the access controller 30 successfully authenticates the hosts 10 and 40 to be part of a PVPN, it has also registered respective session keys established during the authentication procedure for every host authenticated. On the basis of these session keys, the access controller generates, in step S340, new keys to be used in the PVPN setup by each host. The generation of the new keys may be based, for example, on the following logic:
New-key=SHA1(Existing-key|IP address of the host|PVPN-id|Sequence Number),

Wherein SHA1 represents a secure hash algorithm (e.g. according to RFC3174), existing-key means the session key shared with the host in question, IP address of the host is related to the host in question, PVPN-id is a unique identifier associated with a particular gateway which is assigned by the access controller in the response to the authentication message, and the Sequence Number is a random integer present in the authentication message sent by the host. It is to be noted that also the host in question generates a similar key for use within the PVPN.

The access controller may generate one key each for integrity protection and ciphering, or a single key. In any case, the access controller 30 subsequently transfers, in step S350, the key(s) to the gateway 20, i.e. the key(s) of every host having performed an authentication procedure with the access controller 30. In addition, identification data related to the host in question, such as the name and the IP address of the host in question, and any other parameters needed for a secure communication are transmitted with the new key(s) to the gateway 20. Specifically, the access controller 30 constructs a new IP message with these parameters, encrypts the packet contents using the session key it shares with the gateway 20 and transmits the encrypted packet. This is shown in FIG. 1 by means of the arrow T31. The gateway 20 decrypts the packet using the shared session key and records the details (i.e., name, IP address and the New-key as derived above) in a memory (step S360). Thus, the gateway is provided with data keys and identification information of the hosts which performed authentication with the access controller and intend to participate in the PVPN. Furthermore, it is now possible that the hosts 10, 40 communicate with the gateway 20 securely, i.e. via a respective secure channel indicated in FIG. 1 at reference signs SC15 and SC45.

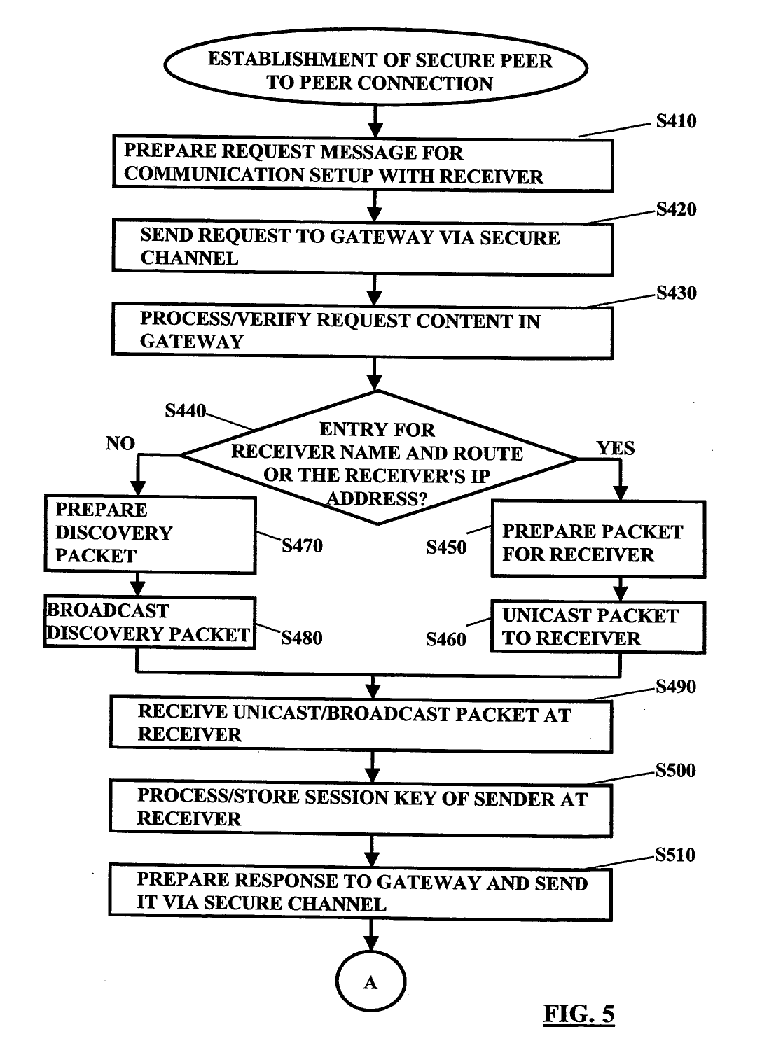

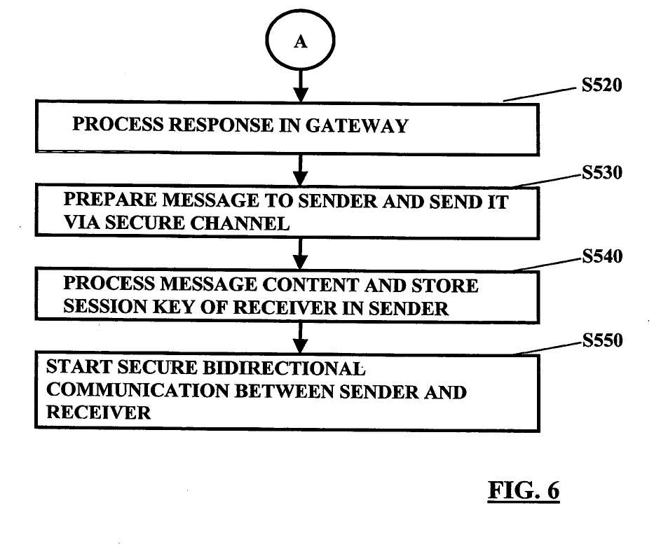

Next, an example for explaining the establishment of a secure peer-to-peer connection via PVPN is described with reference to FIGS. 5 and 6. The combined flowchart of FIGS. 5 and 6 corresponds to the sub-routine according to step S40 in FIG. 2.

In the description below, the term “New-key-sender” refers to a key generated as described above by a network element or host (e.g. host 10 in FIG. 1) that is attempting to initiate a communication with a receiver (i.e. another host, such as host 40) which has similarly derived “New-key-receiver”. As mentioned above, both the keys are available at the gateway 20 as a result of the signaling T31 and step S350.

When the network nodes have performed the authentication procedure with the access controller 30 and the access controller 30 has transmitted the data key information to the gateway 20, the establishment of the secure connection can be started. When a sender, such as the calling host 10, wishes to communicate with another network element, such as the host 40, as a receiver, it first needs to resolve a user-friendly name, such as a SIP URI, to an IP address. Such a construct will be referred to hereinafter as a name. The sender 10 first generates a session key Sₖₛ. Then, the sender constructs or prepares a request for resolving the receiver's name. This request includes, for example, the sender's name, its IP address, the session key Sₖₛ, a session key length and an algorithm to be used for encryption, as well as the receiver's name. The construct comprising the session key, the key length and the algorithm will be referred to also as the key-tuple.

The sender 10 encrypts the request prepared as described above by using the New-key-sender (step S410) and transmits the packet towards the gateway 20 (step S420). The sender 10 may use an available routing method to ensure that the request reaches the gateway 20. This is indicated in FIG. 1 by means of the upper chain-dotted arrow at reference sign T18.

Since the gateway 20 is provided with a corresponding New-key-sender from the access controller 30 (in step S350), it is able to decrypt the message containing the request. In step S430, the gateway 20 processes the request message from the sender 10 by decrypting it and verifying that the sender is authorized to participate with the PVPN. It is to be noted that the gateway 20 itself is not able to authenticate the host 10, but it can decrypt packets sent by a host. This allows a host to trust the gateway by means of transitive trust between the host and the access controller. The gateway 20 first verifies if the name and IP addresses of the sender 10 match the values it has received from the access controller 30.

Then, the gateway 20 checks whether there is receiver is reachable at this instant (step S440). In other words, the gateway 20 may consult corresponding tables so as to locate an IP address corresponding to the receiver's name in the request.

If an entry for the receiver's name is found and a route exists for the receiver's IP address (YES in step S440), the gateway 20 prepares, in step S450, a packet to be sent to the receiver (i.e. host 40) including the name, IP address and the key-tuple from the sender and encrypts the packet by using New-key-receiver it shares with the receiver (which has been transmitted by the access controller 30 in step S350). Then the packet is unicast towards the receiver or host 40 (step S460).

On the other hand, if an entry is not found for the receiver's name or a route does not exist for the IP address corresponding to the receiver's name (NO in step S440), the gateway 20 constructs a packet to resolve either the name or the route or both. This packet is also called a discovery packet. In this discovery packet, the gateway 20 also includes the sender's name, IP address, the key-tuple, and encrypts the packet by using New-key-receiver (step S470). Then, the discovery packet is broadcast so as to be transmitted to the receiver (step S480). In other words, the gateway 20 resolves the receiver's name to its IP address and establishes a route to the receiver.

When the unicast or the broadcast packet reaches the receiver or host 40 in step S490 (also indicated by the upper chain-dotted arrow T48 in FIG. 1), the receiver processes the received data by decrypting the packet using New-key-receiver (step S500). In addition the receiver records the sender's session key-tuple for future communication in a memory (not shown). Then, in step S510, the receiver (i.e. the host 40) prepares a response message comprising its own name, IP address and a session key-tuple which is similar to that described above. The preparation comprises also an encryption of the message by the receiver using again New-key-receiver. When the response message or packet is prepared it is transmitted to the gateway 20.

When the response message to the message of the gateway 20, such as the discovery message, is received at the gateway 20, which is indicated by the lower chain-dotted arrow at T48 in FIG. 1, it processes the response message and decrypts the message using New-key-receiver (step S520). Then, the gateway 20 re-encrypts the content of the response message by using New-key-sender and forwards the thus prepared message to the sender 10 (step S530). This is also shown in FIG. 1 by the lower chain dotted arrow at T18. The sender 10 processes the message received from the gateway 20 and derives and stores the session key of the receiver 40 (step S540). Now, both the sender 10 and the receiver 40 have each other's session key-tuples and are able to secure their communication.

It is to be noted that both the peers 10 and 40 may also have established routing through the gateway 20 to each other. Hence, in step S550, a secure bidirectional communication can begin between the peers. In the communication path between the peers, it is not necessary that the gateway 20 is included.

As described above there is proposed a mechanism for establishing a secure communication between network elements in a communication network. The network nodes execute an authentication procedure with an authentication network element. The authentication network may also one of the network elements as a gateway element. Then, a respective data key for the network elements authenticated is generated and distributed to the gateway element by using a secure channel between the authentication network element and the gateway element. The data keys are stored the data keys in the gateway element. When a secure communication is to be setup, a respective session key is generated in the network elements intending to participate in the secure communication. The session keys are exchanged between the network elements intending to participate in the secure communication via secure channels between the gateway element and the network elements.

It should be understood that the above description and accompanying figures are merely intended to illustrate the present invention by way of example only. The preferred embodiments of the present invention may thus vary within the scope of the attached claims.

What is claimed:

1. A method of establishing a secure communication between a plurality of network elements in a communication network, the method comprising steps of:
executing an authentication procedure for the plurality of network elements with an authentication network element;
setting one of the plurality of network elements as a gateway element;
generating, in the authentication network element, respective data keys for the plurality of network elements authenticated;
distributing the respective data keys of the plurality of network elements to the gateway element by using a secure channel between the authentication network element and the gateway element and storing the respective data keys in the gateway element;
generating respective session keys for the plurality of network elements intending to participate in the secure communication;
exchanging the respective session keys between the network elements intending to participate in the secure communication via secure channels between the gateway element and the plurality of network elements.

2. The method according to claim 1, wherein the step of executing the authentication procedure for the plurality of network elements comprises a step of performing an authentication and key agreement procedure between a respective one of the plurality of network elements and the authentication network element.

3. The method according to claim 1, wherein the step of executing the authentication procedure for the plurality of network elements comprises a step of transmitting, by one of the plurality of network elements, an indication of willingness to become the gateway element, wherein the step of setting of one of the plurality of network elements as the gateway element is performed by processing the indication of willingness.

4. The method according to claim 1, wherein the step of generating, in the authentication network element, at least one respective data key comprises a step of using at least one of the respective session keys generated in the authentication procedure of a respective network element, identification data of the network element, and an identification element associated with the gateway element, for calculating the at least one respective data key of a network device.

5. The method according to claim 1, wherein the step of exchanging respective session keys between the plurality of network elements intending to participate in the secure communication comprises the steps of
transmitting a first packet comprising a session key generated by one network element and data identifying a destination network element to a gateway node by using a data key of the one network element for encrypting the first packet,
decrypting the first packet by using the data key of the one network element being stored in the gateway element,
processing a content of the first packet for determining the destination network element, and
forwarding to the destination network element the information comprised in the first packet using a second packet encrypted by the gateway element with the data key stored for the destination network element.

6. The method according to claim 1, wherein the step of distributing the respective data keys of the plurality of network elements to the gateway element comprises a step of using the respective session keys generated in the authentication procedure of the gateway element at the authentication network element for encryption/decryption of information related to the respective data keys.

7. The method according to claim 1, wherein the plurality network elements are hosts comprising mobile hosts of the communication network.

8. The method according to claim 1, wherein the gateway element is a router for the network elements which is configured to provide access to external networks comprising the Internet, and internal networks comprising an Intranet.

9. The method according to claim 1, wherein the authentication network element is an access network controller of a provider network.

10. The method according to claim 1, wherein the secure communication is established in a proximity network environment comprising a peer-to-peer virtual private network environment.

11. The method according to claim 1, wherein after the step of exchanging respective session keys between the plurality of network elements intending to participate in the secure communication, a bidirectional secure communication session is established, wherein the gateway element is not part of the communication path.

12. A system for establishing a secure communication between a plurality of network elements in a communication network, the system comprising:
a gateway element; and
an authentication network element being connectable to the gateway element, wherein
the plurality of network elements are operably connected and configured to execute an authentication procedure with the authentication network element,
the authentication network element being configured to
set one of the plurality of network elements as the gateway element,
generate respective data keys for the plurality of network elements authenticated, and
distribute the respective data keys of the plurality of network elements to the gateway element by using a secure channel between the authentication network element and the gateway element, and
the gateway element is adapted to store the respective data keys;
wherein the plurality of network elements are further configured to generate, when intending to participate in a secure communication, respective session keys;
and the gateway element is further configured to support an exchange of the respective session keys between the plurality of network elements intending to participate in the secure communication using secure channels between the gateway element and the plurality of network elements.

13. The system according to claim 12, wherein the plurality of network elements are operably connected and configured to execute the authentication procedure using an authentication and key agreement procedure between a respective one of the plurality of network elements and the authentication network element.

14. The system according to claim 12, wherein at least one of the plurality of network elements is operably connected and configured to transmit, during the execution of the authentication procedure, an indication of willingness to become the gateway element, wherein the authentication network element is configured to set one of the plurality of network elements as the gateway element by processing the indication of willingness.

15. The system according to claim 12, wherein, in the generation of at least one respective data key, the authentication network element is configured to use at least one of the respective session keys generated in the authentication procedure of the respective network element, identification data of the network element, and an identification element associated with the gateway element, for calculating the at least one respective data key of a network device.

16. The system according to claim 12, wherein for the exchange of the respective session keys between the plurality of network elements intending to participate in the secure communication, the plurality of network elements are configured to
transmit a first packet comprising a session key generated by one network element and data identifying a destination network element to the gateway node by using a data key of the one network element for encrypting the packet, and
the gateway element is adapted to
decrypt the first packet by using the data key of the one network element being stored in the gateway element,
process a content of the first packet for determining the destination network element, and
forward to the destination network element the information comprised in the first packet using a second packet encrypted by the gateway element with the data key stored for the destination network element.

17. The system according to claim 12, wherein the authentication network element is configured to distribute the respective data keys of the plurality of network elements to the gateway element by using the respective session keys generated in the authentication procedure of the gateway element for encryption/decryption of information related to the respective data keys.

18. The system according to claim 12, wherein the plurality of network elements are hosts comprising mobile hosts of the communication network.

19. The system according to claim 12, wherein the gateway element is a router for the network elements which is configured to provide access to external networks comprising the Internet, and internal networks comprising an Intranet.

20. The system according to claim 12, wherein the authentication network element is an access network controller of a provider network.

21. The system according to claim 12, wherein the system is applicable for a secure communication being established in a proximity network environment comprising a peer-to-peer virtual private network environment.

22. The system according to claim 12, wherein after the exchange of the respective session keys between the network elements intending to participate in the secure communication is completed, the plurality of network elements are operably connected to as well as configured to establish a bidirectional secure communication session, wherein the gateway element is not part of the communication path.

23. A gateway element usable in an establishment of a secure communication between network elements in a communication network, the gateway element comprising:
authenticating means adapted to execute an authentication procedure with an authentication network element;
receiving means for receiving from the authentication network element data keys of the network elements authenticated at the authentication network element by using a secure channel between the authentication network element and the gateway element; and
storing means for storing the data keys of the network elements,
wherein the gateway element is further adapted to support an exchange of respective session keys between the network elements intending to participate in the secure communication using secure channels between the gateway element and the network elements.

24. The gateway element according to claim 23, wherein the gateway element executes the authentication procedure using an authentication and key agreement procedure with the authentication network element.

25. The gateway element according to claim 23, wherein the gateway element is configured
to transmit, during the execution of the authentication procedure, an indication of willingness to become the gateway element, and
to receive from the authentication network element an indication to be set as the gateway element.

26. The gateway element according to claim 23, wherein the data key received from the authentication network element and stored in the gateway element is based on at least one of the respective session keys generated in the authentication procedure of a network element, identification data of the network element, and an identification element associated with the gateway element.

27. The gateway element according to claim 23, wherein, at the exchange of the respective session keys between the network elements intending to participate in the secure communication, the gateway element is configured
to receive a first packet comprising a session key generated by one network element and data identifying a destination network element, the first packet being encrypted by using a data key of the one network element and decrypted by the data key stored in the gateway element,
to process a content of the first packet for determining the destination network element, and
to forward to the destination network element the information comprised in the first packet using a second packet encrypted with the data key stored for the destination network element.

28. The gateway element according to claim 23, wherein the gateway element is adapted to receive from the authentication network element the respective data keys of the network elements which are transmitted by using the respective session keys generated in the authentication procedure of the gateway element for encryption/decryption of information related to the respective data keys.

29. The gateway element according to claim 23, wherein the network elements are hosts comprising mobile hosts of the communication network.

30. The gateway element according claim 23, wherein the gateway element is a router for the network elements which is configured to provide access to external networks comprising the Internet, and internal networks comprising an Intranet.

31. The gateway element according to claim 23, wherein the authentication network element is an access network controller of a provider network.

32. The gateway element according to claim 23, wherein the gateway element is applicable for a secure communication being established in a proximity network environment comprising in a peer-to-peer virtual private network environment.

33. The gateway element according to claim 23, wherein the gateway element is not part of a bidirectional secure communication session between network elements after the exchange of the respective session keys between the network elements intending to participate in the secure communication is completed.

34. An apparatus, comprising:
a gateway element usable in an establishment of a secure communication between network elements in a communication network, the gateway element being configured
to execute an authentication procedure with an authentication network element,
to receive from the authentication network element data keys of network elements authenticated at the authentication network element by using a secure channel between the authentication network element and the gateway element, and
store the data keys of the network elements,
wherein the gateway element is further configured to support an exchange of respective session keys between the network elements intending to participate in the secure communication using secure channels between the gateway element and the network elements.

35. An apparatus, comprising:
a gateway element usable in an establishment of a secure communication between network elements in a communication network, the gateway element being configured
to receive a first message from a sending network element indicating a request to participate in a secure communication, said first message comprising data identifying a destination network element,
to verify that the gateway element has an entry for a route to the destination network element,
to resolve the data identifying the destination network element to corresponding address data and to establish the route to the destination network element using the address data, when no entry for a route is found, or
to unicast a second message directly to the destination network element, when an entry for a route is found.

36. An apparatus, comprising:
an authentication network element usable for establishing a secure communication between network elements in a communication network, the authentication network element being configured
to execute an authentication procedure with network elements,
to set one of the network elements as a gateway element,
to generate a respective data key for the network elements authenticated, and
to distribute the respective data keys of the network elements to the gateway element by using a secure channel between the authentication network element and the gateway element.

37. An apparatus, comprising:
a terminal node configured to establish a secure communication in a communication network, the terminal node being configured
to perform an authentication with an authentication network element,
to generate, when intending to participate in a secure communication, a respective session key,
to transmit the respective session key to a gateway element, and
to exchange session keys with at least one other terminal element intending to participate in the secure communication using a secure channel to the gateway element.
